(19) United States
(12) Patent Application Publication
(10) Pub. No.: US 2025/0187407 A1
(43) Pub. Date: Jun. 12, 2025

(54) Bearing Assembly of a Refrigerant Compressor on a Chassis of a Motor Vehicle, as Well as a Motor Vehicle

(71) Applicant: Mercedes-Benz Group AG, Stuttgart (DE)

(72) Inventors: Andreas LUECKEMANN, Stuttgart (DE); Gernot JAEGER, Gaertringen (DE); Peter LEHMANN, Herrenberg (DE); Dirk SCHNEIDER, Calw-Alzenberg (DE)

(21) Appl. No.: 18/686,274

(22) PCT Filed: Jul. 18, 2022
(86) PCT No.: PCT/EP2022/069995

§ 371 Date: Feb. 23, 2024

(30) Foreign Application Priority Data
Aug. 24, 2021 (DE) 10 2021 004 340.5

(51) Int. Cl. B60H 1/32

(52) U.S. Cl. CPC B60H 1/3229

(57) ABSTRACT

A bearing assembly includes at least one sliding incline, via which a refrigerant compressor is steerable in a targeted manner in a direction in the event of an accident-induced displacement of the refrigerant compressor. The refrigerant compressor is mounted via a holder on a chassis of a motor vehicle.

### BACKGROUND AND SUMMARY OF THE INVENTION

The invention relates to a bearing assembly of a refrigerant compressor on a chassis of a motor vehicle, as well as a motor vehicle incorporating the same.

A bearing assembly of an electric powertrain on a motor vehicle shell is taken as known from DE 10 2016 009 395 B4. The bearing assembly comprises a frame structure which is held on the motor vehicle shell. The powertrain comprising at least one electric drive is supported by the frame structure.

The present invention provides a bearing assembly of a refrigerant compressor on a chassis of a motor vehicle, as well as a motor vehicle, such that said assembly and vehicle behave particularly advantageously in the event of an accident.

A first aspect of the invention relates to a bearing assembly of a refrigerant compressor on a chassis, preferably formed as a self-supporting chassis and also referred to as a shell, of a motor vehicle, in particular a passenger car. In the bearing assembly, the refrigerant compressor is mounted on the chassis by way of a holder that is formed in particular separately from the refrigerant compressor and separately from the chassis. To this end, for example, on the one hand the refrigerant compressor is connected to the holder, and on the other hand the holder is connected to the chassis. Preferably, the refrigerant compressor is an electric refrigerant compressor (eKMV). The refrigerant compressor can be a component of an air conditioning unit of the motor vehicle, the air conditioning unit of which is preferably a compression refrigeration machine or at least can be operated as a compression refrigeration machine. Therefore, a refrigerant can be conveyed and compressed by means of the refrigerant compressor.

The bearing assembly is characterised by at least one sliding incline, by means of which the refrigerant compressor can be steered at least indirectly in a targeted manner in a direction in the event of an accident-induced displacement of the refrigerant compressor that takes place, in particular, in the vehicle longitudinal direction and thus for example from the front to the rear. The accident-induced displacement of the refrigerant compressor results from an accident-induced application of force, which here, for example, acts in the vehicle longitudinal direction from the front to the rear and in this case results, for example, from a frontal impact of the motor vehicle. During the accident-induced displacement of the refrigerant compressor, the refrigerant compressor is moved in relation to the chassis. In this case, the sliding incline provides that the refrigerant compressor will not be displaced in a random direction of movement when it is displaced as a result of an accident; rather, the sliding incline causes a targeted accident-induced displacement or movement of the refrigerant compressor in the direction, said displacement taking place in relation to the chassis. For example, the sliding incline is at least indirectly provided on the refrigerant compressor, which is also simply referred to as compressor. This means in particular that the sliding incline is provided, for example, on a component which in particular is formed separately from the compressor and is coupled to the compressor and can thus be displaced in the compressor. Thus, the sliding incline can, for example, be displaced together with the refrigerant compressor. When the refrigerant compressor and the sliding incline are displaced as a result of an accident, the sliding incline for example slides against a structural element of the motor vehicle, whereby the refrigerant compressor is displaced in the direction in a targeted manner. Furthermore, it is conceivable that the sliding incline is provided on a component, such as the aforementioned structural element for example, such that, for example, the compressor is displaced in relation to the component and thus in relation to the sliding incline when it is displaced as a result of an accident. The refrigerant compressor can slide at least indirectly—i.e. for example via an element which in particular is formed separately from the compressor, is able to be displaced with the compressor and is coupled with the compressor for example—on the sliding incline provided on the component or the structural element and thus be steered in a targeted manner in the direction.

In the event of the accident-induced displacement of the refrigerant compressor, the refrigerant compressor can, for example, be guided around a region or guided past the region by the targeted steering of the refrigerant compressor by means of the sliding incline and thus prevented from excessively encroaching into said region. Therefore, it can be avoided for example that a component of the motor vehicle arranged in the region is excessively damaged by the accident-induced displacement of the refrigerant compressor. In particular, it is conceivable that an electric energy store formed, for example, as a high-voltage component, in particular as a high-voltage battery, is arranged in said region. Due to the invention, an excessive, accident-induced encroachment of the refrigerant compressor into the region can now be avoided, whereby the electric energy store for example can be protected from excessive damage or from excessive, accident-induced loads. In particular, it is conceivable that when the refrigerant compressor is displaced as a result of an accident, the latter can be steered by means of the sliding incline in a targeted manner in the direction, and thus steered in a targeted manner into a receiving region formed as a hollow chamber for example. Therefore, excessive, accident-induced loads on components arranged in the region, such as the electric energy store, for example, can be avoided. The receiving region is, for example, a hollow chamber of a floor cross-member, in particular of a pedal floor cross-member, of the chassis.

The sliding incline is or acts as a ramp, by means of which the refrigerant compressor is guided in a targeted manner when it is displaced as a result of an accident and therefore is steered in a targeted manner. In this case, the sliding incline, in particular at least one sliding surface of the sliding incline, is formed, for example, at least essentially flat. Therefore, the refrigerant compressor can be steered in a specifically targeted manner in the direction, as the sliding surface can slide advantageously against the structural element, or the element can slide advantageously against the sliding surface. Due to the targeted steering of the refrigerant compressor during its accident-induced displacement, excessively high deformations in the region away from which the refrigerant compressor can be steered can be avoided, for example. Therefore, for example, a short-circuit of the electric energy store arranged in the region and/or other damage can be avoided.

In order to be able to steer the refrigerant compressor particularly advantageously during its accident-induced displacement and thus avoid excessive damage at least of a component, such as the electric energy store, it is provided in an embodiment of the invention that the sliding incline, in particular the sliding surface, and therefore the direction run diagonally to the vehicle longitudinal direction from the front bottom to the rear top. If the refrigerant compressor is displaced during the accident-induced displacement, resulting for example from a frontal impact of the motor vehicle, in the vehicle longitudinal direction from the front to the rear in relation to the chassis, such that the accident-induced displacement of the refrigerant compressor is an accident-induced rearwards displacement or an accident-induced rearwards shift, the sliding incline causes the refrigerant compressor to be moved upwards in the vehicle vertical direction, i.e. to rise or ride up. Therefore, for example, an excessive, accident-induced application of force on the component arranged in the region and formed, for example, as an electric energy store can be avoided. In particular, it is provided that the region adjoins the refrigerant compressor in the vehicle longitudinal direction towards the rear. The refrigerant compressor is at least partially moved upwards in the vehicle vertical direction, in particular diagonally to the vehicle vertical direction from the front bottom to the rear top, by means of the sliding incline, and therefore at least guided past a part of the region so that the refrigerant compressor does not or does not excessively collide with the component arranged in the region or does not or does not excessively penetrate the component. In particular, the refrigerant compressor is steered in a targeted manner into a circumvention region, such as for example the aforementioned receiving region, by means of the sliding incline, whereby excessive deformations can be avoided.

In order to be able to steer the refrigerant compressor in a particularly targeted manner during the accident-induced displacement of the latter, it is provided in a further embodiment of the invention that the sliding incline is provided on a holder element on the compressor side, which can be displaced together with the refrigerant compressor. The holder element is also referred to as a first holder element and is the aforementioned component, for example, on which the sliding incline is provided. In particular, the first holder element is formed separately from the refrigerant compressor and is coupled at least indirectly with the refrigerant compressor and therefore can be displaced with the refrigerant compressor in the event of an accident. By means of the sliding incline, the first holder element and, via the latter, the refrigerant compressor are steered in a targeted manner in the direction during the accident-induced displacement of the refrigerant compressor, the accident-induced displacement of which is associated with an accident-induced displacement of the first holder element.

A further embodiment is characterised by at least one chassis-side, second sliding incline which corresponds to the sliding incline and by means of which the refrigerant compressor can be steered in a targeted manner in the direction when the compressor side, first sliding incline slides against the chassis-side, second sliding incline during the accident-induced displacement of the refrigerant compressor. In other words, as the second sliding incline is a chassis-side sliding incline, a relative movement occurs between the first sliding incline and the second sliding incline during the accident-induced displacement of the refrigerant compressor, in such a way that the sliding inclines slide against each other. It is conceivable that the sliding inclines are already in contact with each other, in particular directly, even before the accident-induced displacement and thus in a normal state of the bearing assembly, or in the normal state, the sliding inclines are spaced apart from each other such that the sliding inclines in particular only come into mutual contact, in particular directly, as a result of the accident-induced displacement. During the course of the accident-induced displacement of the refrigerant compressor and thus of the first sliding incline, the sliding inclines slide, in particular directly, against each other. The sliding inclines therefore cause a targeted and defined, accident-induced movement of the refrigerant compressor in the direction, whereby the refrigerant compressor can be at least partially withheld or steered away from the region in a defined and targeted manner. In this case, it is preferably provided that (also) the second sliding incline has a second sliding surface against which the first sliding incline, in particular the first gliding surface, slides, particularly directly, during the accident-induced displacement. Preferably, the second sliding surface is at least essentially level. Particularly preferably, the respective sliding incline, in particular the respective sliding surface, extends in a respective plane which is also referred to as sliding plane. The sliding plane runs preferably diagonally to the vehicle vertical direction. Particularly preferably, the vehicle transverse direction runs in the sliding plane. Therefore, particularly advantageous guidance of the refrigerant compressor can be ensured. The second sliding incline is also or also functions as a ramp, whereby the ramps slide against each other, in particular directly. Therefore, the refrigerant compressor can be held far away from the region or steered away from the latter in a defined and targeted manner.

In a further, particularly advantageous embodiment of the invention, the chassis-side, second sliding incline is provided on a second holder element of the holder, which is formed separately from the first holder element and is fixed on the chassis and thus on the chassis side. Preferably, the second holder element is fixed on the chassis, i.e. connected immovably to the chassis.

The compressor-side, first holder element is connected to the second holder element, such that the refrigerant compressor is connected with the second holder element by way of the first holder element and to the chassis by way of the second holder element, in particular in such a way that the first holder element is connected to the chassis by way of the second holder element. On the one hand, a particularly advantageous guidance of the refrigerant compressor can therefore be realised during the accident-induced displacement. On the other hand, a particularly advantageous vibration decoupling of the refrigerant compressor from the chassis can therefore be realised. In other words, it is therefore possible to mount the refrigerant compressor particularly advantageously in a vibration-decoupled manner on the chassis, such that, for example during an operation of the refrigerant compressor, occurring vibrations of the refrigerant compressor are not transmitted or at least are not transmitted excessively to the chassis.

A further embodiment provides that the compressor side, first holder element is positioned on the chassis side, second holder element via at least one first bearing element formed from an elastomer and thus elastically deformable, and thus is connected to the chassis-side, second holder element. As a result, mounting of the refrigerant compressor on the chassis can be achieved that is particularly advantageous both in terms of an accident and vibrations. For example, the first bearing element allows relative movements between the holder elements when the refrigerant compressor vibrates, whereby the first bearing element is elastically deformed during such relative movements between the holder elements. Therefore, vibrations are particularly advantageously absorbed. Furthermore, a particularly advantageous positioning of the refrigerant compressor can therefore be achieved, such that the refrigerant compressor can be advantageously steered, i.e. guided, during its accident-induced displacement.

In a further, particularly advantageous embodiment of the invention, the refrigerant compressor is mounted on the compressor-side, first holder element via at least one second bearing element that is formed from an elastomer and thus elastically deformable. Therefore, the refrigeration compressor can be mounted on the chassis in a manner that is particularly advantageous in terms of vibrations and vibration-decoupling. Furthermore, as a result an advantageous, accident-induced movement of the refrigerant compressor can be allowed.

In order to be able to position the refrigerant compressor particularly advantageously, in particular in relation to the chassis, and as a result steer and therefore guide the refrigerant compressor particularly advantageously during the accident-induced displacement, it is provided in a further embodiment of the invention that the holder has a third holder element formed separately from the holder elements and fixed, in particular fixed in an immovable manner, to the compressor-side second holder element, wherein the refrigerant compressor is mounted on the third holder element via the second bearing element.

Lastly, it has proven to be particularly advantageous when the chassis-side, second sliding incline and therefore the direction run diagonally to the vehicle longitudinal direction from the front bottom to the rear top. Therefore, a particularly targeted and defined ascent of the refrigerant compressor can be achieved during the accident-induced displacement of the latter by means of the sliding inclines, whereby the refrigerant compressor can be particularly advantageously steered away or held away from the region.

A second aspect of the invention relates to a motor vehicle, preferably formed as a passenger car, which has a bearing assembly according to the first aspect of the invention. Advantages and advantageous embodiments of the first aspect of the invention are to be regarded as advantages and advantageous embodiments of the second aspect of the invention and vice versa.

Further advantages and details of the invention arise from the following description and with the aid of the drawings.

### BRIEF DESCRIPTION OF THE DRAWINGS

FIG. 1 is a partially schematic and sectional side view of a bearing assembly of a refrigerant compressor on a chassis of a motor vehicle according to at least one embodiment;

FIG. 2 is a schematic perspective view of the refrigerant compressor and a holder according to a first embodiment, by way of which the refrigerant compressor is mounted on the chassis according to at least one embodiment;

FIG. 3 is a further schematic perspective view of the refrigerant compressor and the holder according to at least one embodiment;

FIG. 4 is a schematic and lateral view of the holder according to at least one embodiment;

FIG. 5 is a schematic side view of the holder and the refrigerant compressor during an accident-induced application of force, acting in the vehicle longitudinal direction from front to rear, which causes an accident-induced displacement of the refrigerant compressor according to at least one embodiment; and

FIG. 6 is a schematic perspective view of the holder according to at least one embodiment.

### DETAILED DESCRIPTION OF THE DRAWINGS

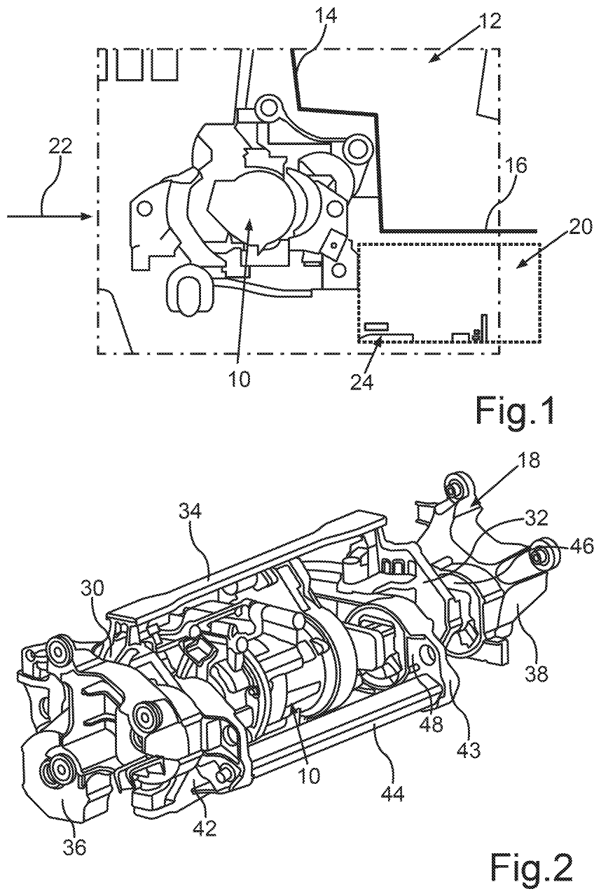

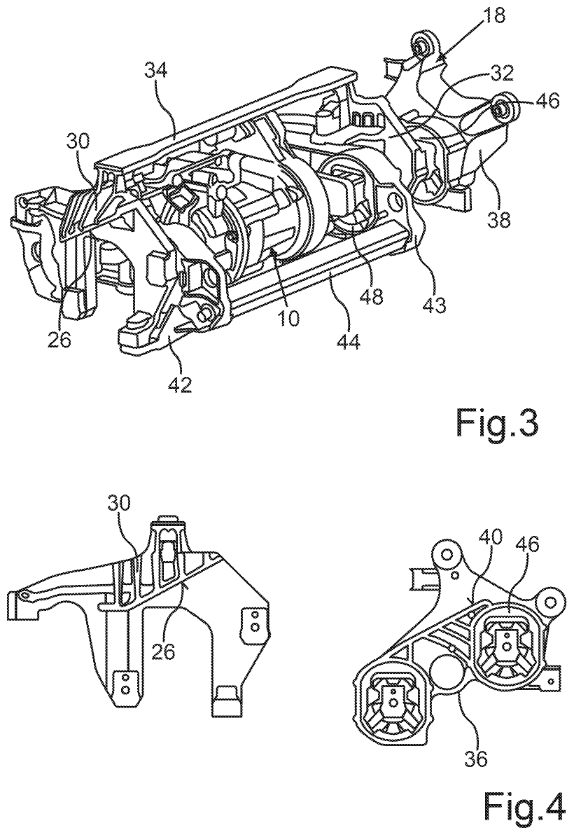

FIG. 1 partially exhibits a bearing assembly of a refrigerant compressor 10, in a schematic and sectional side view, on a chassis 12, which is formed as a self-supporting chassis and also referred to as a shell, of a motor vehicle formed as a passenger car. In particular, an end wall 14 and pedal base 16 of the chassis 12 can be seen in FIG. 1, wherein the interior space of the motor vehicle is at least partially restricted in the vehicle vertical direction at the bottom by the pedal base 16 and in the vehicle longitudinal direction at the front by the cowl 14. As can be seen particularly well in conjunction with FIG. 2, in the bearing assembly, the refrigerant compressor 10 is mounted on the chassis 12 by way of a holder 18 formed separately from the chassis 12 and separately from the refrigerant compressor 10. As is explained in more detail in the following, the holder 18 is a multi-part holder which is also referred to as a holder device. In particular, the holder 18 is or comprises a frame, also referred to as a support frame, by way of which the refrigerant compressor 10 is mounted on the chassis 12. Therefore, FIGS. 1 to 5 exhibit a first embodiment of the holder 18.

For example, the refrigerant compressor 10 is a component of an air conditioning unit of the motor vehicle, the air conditioning unit of which is a compression refrigeration machine or at least can be operated as a compression refrigeration machine. As a result, the air conditioning unit has a refrigerant flowing through a refrigeration circuit, in which the refrigerant compressor 10 is arranged. By means of the refrigerant compressor 10, the refrigerant can be conveyed through the refrigeration circuit and compressed. In particular, the refrigerant compressor 10 is an electric refrigerant compressor. This means that the refrigerant compressor 10 has a conveying element for conveying and compressing the refrigerant and an electric motor, by means of which the conveying element can be driven by using electrical energy in order to convey and compress the refrigerant.

The motor vehicle is a hybrid vehicle, for example, or an electric vehicle, in particular a battery electric vehicle (BEV). In this case, the motor vehicle has an electric energy store 20, in which electric energy is stored or should be stored. Preferably, the energy store 20 is a high-voltage component, in particular a high-voltage battery (HV battery). From FIG. 1 it can be seen that the electric energy store 20 is arranged at least partially, in particular at least predominantly or completely, behind the refrigerant compressor 10 in the vehicle longitudinal direction, in particular in such a way that at least one first partial region of the refrigerant compressor 10 is overlapped by at least one second partial region of the energy store 20, as viewed towards the rear in the vehicle longitudinal direction. In turn, at least the second partial region of the energy store 20 is overlapped by the first partial region of the refrigerant compressor 10, as viewed in the vehicle longitudinal direction towards the front.

In FIG. 1 an accident-induced application of force to the motor vehicle and thus to the refrigerant compressor 10 is illustrated by an arrow 22, wherein in the embodiment exhibited in FIG. 1, the accident-induced application of force acts in the vehicle longitudinal direction from the front to the rear. For example, the accident-induced application of force results from a frontal impact or from a head-on collision of the motor vehicle. Due to the accident-induced application of force, the refrigerant compressor 10 is displaced rearwards, relative to the chassis 12 in the vehicle longitudinal direction, such that the accident-induced displacement of the refrigerant compressor 10 is an accident-induced rearwards displacement or rearwards shift in the vehicle longitudinal direction.

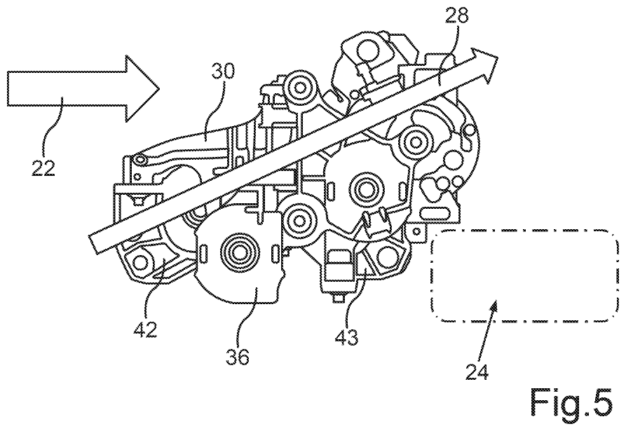

In order to avoid the refrigerant compressor 10 excessively encroaching into a region 24 in which the energy store 20 is arranged during the accident-induced displacement of the refrigerant compressor 10, such that excessive loading or impact on the energy store 20 or excessive deformation in the region 24 can be avoided, two lateral, first sliding inclines are provided in the bearing assembly—as can be seen from FIGS. 1 to 4—of which the sliding incline marked with 26 can be seen in the vehicle transverse direction on the left. As will be explained in more detail in the following, when it is displaced rearwards as a result of an accident, the refrigerant compressor 10 can be steered by means of the first sliding incline 26 at least indirectly in a targeted manner in a direction illustrated by an arrow 28 in FIG. 5 which runs diagonally to the vehicle longitudinal direction from the front bottom to the rear top because the first sliding inclines 26 run diagonally to the vehicle longitudinal direction from the front bottom to the rear top.

As can be seen from FIGS. 2 to 4, the holder 18 has two, first, lateral holder elements 30 and 32, for example formed separately from each other, wherein the holder element 30 is arranged on the left side and the holder element 32 is arranged on the right side of the refrigerant compressor 10 or the chassis and thus the motor vehicle. In this case, the refrigerant compressor 10 is arranged at least partially between the holder elements 30 and 32 in the vehicle transverse direction. The left, first sliding incline 26 is provided on the holder element 30, in particular formed by the holder element 30. The right, first sliding incline, not visible in the figure, is provided on the holder element 32 or formed by the holder element 32. The holder elements 30 and 32 are connected with each other via at least one cross-member 34 of the holder 18, in particular in such a way that the cross-member 34 is directly connected to the holder elements 30 and 32. The holder elements 30 and 32 are compressor-side holder elements of the holder 18 which can be displaced together with the refrigerant compressor 10 as a result of an accident. The holder 18 therefore has two lateral, chassis-side, second holder elements 36 and 38 which can be formed separately from each other. The holder elements 36 and 38 are also respectively formed by the holder elements 30 and 32. The respective holder element 36 or 38 is fixed on the chassis, in particular secured on the chassis. On the respective, second holder element 36 or 38, a respective, second sliding incline, corresponding with the respective first sliding incline 26, is provided, wherein the respective, second sliding incline is formed by the respective, second holder element 36 or 38. In FIG. 4, the second sliding incline provided on the left holder element 36 can be seen and is marked with 40. In particular, it can be seen from FIG. 4 that the second sliding incline 40, provided on the holder element 36, corresponds with the first sliding incline 26, provided on the left holder element 30. The second sliding inclines 40 also run diagonally to the vehicle longitudinal direction from the front bottom to the rear top. As the holder elements 36 and 38 and thus the second sliding inclines 40 are fixed to the chassis, and as the holder elements 30 and 32 and thus the sliding inclines 26 can be displaced with the refrigerant compressor 10 in relation to the chassis as the result of an accident, the sliding inclines 26 slide during the accident-induced rearward displacement of the refrigerant compressor 10 and the holder elements 30 and 32 against the corresponding sliding inclines 40, in particular directly. As the sliding inclines 26 and 40 run diagonally to the vehicle longitudinal direction from the front bottom to the rear top, the direction illustrated by the arrow 28 likewise runs diagonally to the vehicle vertical direction from the front bottom to the rear top. Thus, during the accident-induced displacement, the sliding inclines 26 and 40 cause the holder elements 30 and 32 and the refrigerant compressor 10 with them to rise upwards or slide upwards on the respective inclines, or to be pushed by the crash-induced rearwards displacement forces, in the vehicle vertical direction. Therefore, the refrigerant compressor 10 is steered away at least partially, in particular predominantly or completely, from the region 24 and thus from the energy store 20 or is prevented from encroaching on the region 24 excessively and thus prevented from colliding excessively or excessively hard with the energy store 20.

The holder 18 has two third holder elements 42 and 43 which are formed preferably separately from each other. Furthermore, the holder elements 42 and 43 are formed separately from the holder elements 30 and 32 and separately from the holder elements 36 and 38. The holder 18 has a second cross-member 44 by which the holder elements 42 and 43 are connected with each other, in particular in such a way that the second cross-member 44 is connected directly to the respective holder elements 42 and 43. The holder elements 42 and 43 are also compressor-side holder elements which can be displaced with the refrigerant compressor 10 in the case of an accident, in particular in relation to the chassis 12. In particular it can be provided that the holder elements 42 and 43 are fixed on the holder elements 30 and 32, in particular secured. The holder elements 42 and 43 are also lateral holder elements, wherein the holder element 42 can be arranged on the left side, like holder elements 30 and 36, and the holder element 43 can be arranged on the right side, like holder elements 32 and 38. Therefore, it is provided that the refrigerant compressor 10 is arranged at least partially between the holder elements 42 and 43 in the vehicle transverse direction. Furthermore, in the embodiment exhibited in Fig., the refrigerant compressor 10 is arranged at least partially between the holder elements 36 and 38 in the vehicle transverse direction.

The respective holder element 36 or 38 is a component of a respective, lateral, first elastomeric bearing. The respective, first elastomeric bearing has a respective, first bearing element 46 which is formed from an elastomer and thus is elastically deformable. It can be seen that the respective, compressor-side holder element 30 or 32 is mounted on the respective chassis-side holder element 36 or 38 via the respective first bearing element 46, and therefore is connected to the respective, chassis-side holder element 36 or 38. The first bearing elements 46 allow relative movement, in particular relative vibrations, between the respective holder element 30 or 32 and the respective bearing element 36 or 38. With such relative movements, the bearing elements 46 are elastically deformed, whereby the vibrations are absorbed.

The respective bearing element 30 or 32 is a component of a respective, second elastomeric bearing. The respective, second elastomeric bearing has a respective second bearing element 48, which is formed from an elastomer and thus is elastically deformable. The refrigerant compressor 10 is therefore mounted on the respective, compressor-side holder element 42 or 43 by way of the respective, second bearing element 48, such that the respective, second bearing element 48 allows relative movements, in particular relative vibrations, between the refrigerant compressor 10 and the holder elements 42 and 43. With such relative movements, the bearing elements 48 are elastically deformed, whereby vibrations are absorbed. It can be seen that the refrigerant compressor 10 is mounted on the holder elements 42 and 43 by way of the bearing elements 48. The holder elements 42 and 43 are fixed on the holder elements 30 and 32 and thus mounted on the holder elements 36 and 38 by way of the holder elements 30 and 32. It can also be seen that the refrigerant compressor 10 is mounted on the holder elements 30 and 32 via the bearing elements 48. The bearing elements 46 and 48 ensure vibration decoupling, also referred to as NVH decoupling, such that vibrations of the refrigerant compressor 10 arising during an operation of the refrigerant compressor 10, for example, the vibrations of which refrigerant compressor for example occur in relation to the chassis 12, are not or at least not excessively introduced into the chassis 12.

As the holder elements 30 and 32 can be displaced together with the refrigerant compressor 10 in relation to the chassis 12 in the case of an accident, the holder elements 30 and 32 are movable parts on which the first sliding inclines 26, also referred to as glide inclines, are provided. As the holder elements 36 and 38 are fixed onto the chassis 12, the holder elements 36 and 38 are fixed parts on which the sliding inclines 40, also referred to as glide inclines, are provided. It can be seen particularly well in FIG. 5 that when the refrigerant compressor 10 and thus the holder elements 30 and 32 are displaced backwards as the result of the accident-induced application of force, illustrated by the arrow 22, the sliding inclines 26 slide against the corresponding sliding inclines 40, whereby the holder elements 30 and 32, and the refrigerant compressor 10 via them, are steered in a targeted manner in the direction illustrated by the arrow 28. In so doing, the refrigerant compressor 10 rises up, whereby the latter is prevented from excessively encroaching into the region 24. As a result, excessive deformations in the region 24 can be avoided. Furthermore, an excessive application of force on the energy store 20 can be avoided, such that the energy store 20 can be advantageously protected.

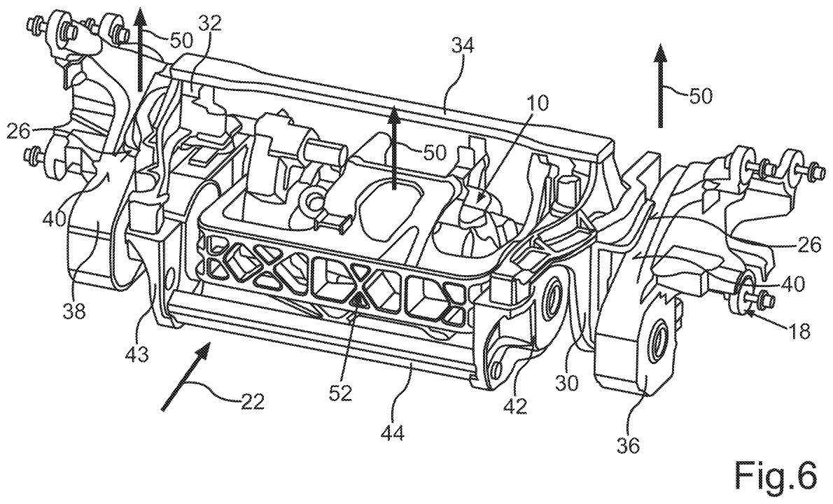

FIG. 6 exhibits a second embodiment of the holder 18. In FIG. 6, both the first, compressor-side sliding inclines 26 of the holder elements 30 and 32 and the chassis-side, second sliding inclines 40 of the holder elements 36 and 38 can be seen. In FIG. 6, arrows 50 illustrate that at least an upwards movement of the refrigerant compressor 10, i.e. a movement of the refrigerant compressor 10 at least upwards in the vehicle vertical direction, is brought about by the sliding inclines 26 and 40 during the accident-induced rearwards displacement of the refrigerant compressor 10 in such a way that the sliding inclines 26 slide, in particular directly, against the sliding inclines 40.

Furthermore, a cage 52 is provided in the second embodiment, by which the refrigerant compressor 10 is at least partially overlapped in the vehicle longitudinal direction towards the front and in the vehicle vertical direction upwards, respectively. The cage 52 is formed separately from the refrigerant compressor 10 and separately from the holder elements 30, 32, 36, 38, 42 and 43 and for example is fixed on the refrigerant compressor 10 and/or on the holder elements 42 and 43.

1-10. (canceled)

11. A bearing assembly of a refrigerant compressor on a chassis of a motor vehicle, wherein the refrigerant compressor is mounted via a holder on the chassis, the bearing assembly comprising:
at least one sliding incline, via which the refrigerant compressor is steerable in a targeted manner in a direction in the event of an accident-induced displacement of the refrigerant compressor.

12. The bearing assembly of claim 11, wherein the sliding incline and the direction run diagonally to the vehicle longitudinal direction from the front bottom to the rear top.

13. The bearing assembly of claim 11, wherein the sliding incline is provided on a holder element on a compressor side, which can be displaced together with the refrigerant compressor.

14. The bearing assembly of claim 13, wherein at least one chassis-side, second sliding incline which corresponds to the sliding incline and by means of which the refrigerant compressor can be steered in a targeted manner in the direction when the compressor-side, first sliding incline slides against the chassis-side, second sliding incline during the accident-induced displacement of the refrigerant compressor.

15. The bearing assembly of claim 14, wherein the chassis-side, second sliding incline is provided on a second holder element of the holder, which is formed separately from the holder element and is fixed on the chassis and thus on the chassis side, and the compressor-side, first holder element is connected to the second holder element of the holder.

16. The bearing assembly of claim 15, wherein the compressor side, first holder element is mounted on the chassis-side, second holder element via at least one first bearing element formed from an elastomer, and thus is connected to the chassis-side, second holder element.

17. The bearing assembly of claim 15, wherein the refrigerant compressor is mounted on the compressor-side, first holder element via at least one second bearing element formed from an elastomer.

18. The bearing assembly of claim 17, wherein the holder has a third holder element formed separately from the holder elements and fixed to the compressor-side, first holder element, wherein the refrigerant compressor is mounted on the third holder element via the second bearing element.

19. The bearing assembly claim 14, wherein the chassis-side, second sliding incline and the direction run diagonally to the vehicle longitudinal direction from the front bottom to the rear top.

20. A motor vehicle, comprising:
a refrigerant compressor mounted via a holder on a chassis of the motor vehicle;
a bearing assembly of the refrigerant compressor, wherein the bearing assembly includes:
at least one sliding incline, via which the refrigerant compressor is steerable in a targeted manner in a direction in the event of an accident-induced displacement of the refrigerant compressor.
